(19) United States
(12) Patent Application Publication
(10) Pub. No.: US 2019/0247882 A1
(43) Pub. Date: Aug. 15, 2019

(54) METHODS AND APPARATUS FOR APPLYING PROTECTIVE FILMS

(71) Applicant: EXEL INDUSTRIES, Paris (FR)

(72) Inventor: Michael DeFillipi, Plymouth, MI (US)

(21) Appl. No.: 16/392,948

(22) Filed: Apr. 24, 2019

Related U.S. Application Data
(63) Continuation-in-part of application No. 15/349,349, filed on Nov. 11, 2016, now Pat. No. 10,315,405.
Application No. 15/349,349 is a continuation-in-part of application No. 14/311,533, filed on Jun. 23, 2014, now Pat. No. 10,000,049.

(51) Int. Cl. B05D 1/26; B05D 7/00; B05D 3/00; B05C 5/02

(52) U.S. Cl. CPC B05D 1/265; B05C 5/0254; B05D 3/002; B05D 7/54

(57) ABSTRACT

A method of applying a polymeric anti-chip coating to an automobile body surface such as a rocker panel using a hydraulic extrusion die to form and emit a non-atomized ribbon of material onto adhering contact with said rocker panel. The ribbon can be varied in width by robotically turning the die about the flow axis and proportionally changing the ratio of material flow to speed of die movement to maintain ribbon thickness.

### CROSS REFERENCE OF CO-PENDING APPLICATION

This application is a continuation-in-part of U.S. patent application Ser. No. 15/349,349, filed Nov. 11, 2016, which is a continuation-in-part of U.S. patent application Ser. No. 14/311,533, filed Jun. 23, 2014 (now U.S. Pat. No. 10,000,049 issued Jun. 19, 2018), the entire contents of each is incorporated herein in its entirety.

### FIELD OF THE INVENTION

Disclosed herein is a method for providing an anti-chip coating of polymeric composition to the rocker panels of an automobile. The apparatus used to carry out the methods may include an applicator die configured to hydraulically deliver a laminarized ribbon of polymer-based film with controlled width, thickness and edge characteristics.

### BACKGROUND OF THE INVENTION

It is known to apply a film or coating of resilient protective polymeric material such as PVC or other polymer to the rocker panels and other locations on automobile bodies to serve as an anti-chip coating. The coating is typically sprayed onto the masked vehicle rocker panel during the painting phase and dried or cured using, for example, standard paint oven convection heating. This sprayed-on method of application requires carefully masking of the body of the vehicle for overspray protection and is labor-intensive. The masking must also be removed and disposed of, adding further cost to the process.

### SUMMARY OF THE DISCLOSURE

The following specification, taken with the drawing figures, describes two processes: first, a process for robotically applying a peelable, temporarily-protective film to the surfaces of a manufactured article such as an automobile, and, second, a process for applying a polymeric anti-chip coating to, for example, a vehicle rocker panel.

The specification also discloses an “extrusion die” for forming and applying ribbons of the film and coating in a precise fashion. It is to be understood, however, that the anti-chip process may be carried out using applicators of other designs, so long as such applicators produce a non-atomized ribbon of material, such as a PVC emulsion with the proper viscosity and speed.

### SUMMARY OF THE CLAIMED INVENTION

In general, this document claims the manner in which the rocker panels of a motor vehicle can be protected against chipping by the robotic application of a non-atomized ribbon of a polymer-based material, such as the materials hereinafter identified. The preferred method of application is hydraulic extrusion. The ribbon preferably has a uniform thickness from edge to edge and can be applied extremely close to a part edge or a seam between adjacent assembled parts without masking. This virtually eliminates problems associated with prior art methods including those that involve spraying, masking and/or removal of overspray.

As further described herein, the preferred applicator is a die with an outlet slot capable of emitting an undivided, i.e., non-atomized ribbon of fluidic material.

For a protective anti-chip film, a film with a uniform thickness of about 350 microns from edge to edge has been found to be successful.

A still further aspect of the inventive subject matter disclosed herein is the overall process of applying an anti-chip coating to the rocker panels of an automobile body. In this case, the material being applied can be a non-atomized, laminar-flowing ribbon of an emulsified polymer such as, but not limited to, polyvinyl chloride (PVC) or a hybrid thereof to a primed rocker panel. In the preferred embodiment, the polymeric PVC ribbon is applied over previously applied primer on the rocker panel but before the application of the base color and clear coat. It has been determined that it is not necessary to wait for the ribbon to completely dry before the paint is applied; i.e., the subsequent coatings can be applied “wet-on-wet,” greatly reducing production time and totally eliminating the need for masking and spraying as are required in the prior art techniques.

In cases where the process requires a ribbon of varying width, the application die can be robotically turned about the axis of material flow during travel along the panel to reduce or increase the width of the applied ribbon. The speed of the die movement or material flow rate can be adjusted to avoid a variation in ribbon thickness as a result of the turning step. In all cases the viscosity of the material is high enough to cause the ribbon to adhere to a vertical rocker panel without significant running or sagging. For wider applications, more than one run of the die may be required to apply two or more parallel and adjacent ribbons.

Other advantages, features, and characteristics of the subject matter disclosed herein, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

The description herein makes reference to the accompanying drawings wherein like reference numerals refer to like parts throughout the several views and wherein:

FIG. 1 is a perspective view of an applicator die as described herein mounted on a robot arm and used to apply a protective film to the hood of an automobile;

FIG. 2 is a schematic view of a representative pattern of runs of the robotically moved applicator die in fully covering an automobile hood;

FIG. 3 is a plan view of the ribbons laid down by the run pattern of FIG. 2;

FIG. 4 is a perspective view of a robotic system for applying an emulsion of PVC as an anti-chip coating on rocker panels according to the process of FIG. 9;

FIG. 5 is an exploded view of an applicator as described m the following

FIG. 6 is a sectional view through the application of FIG. 4;

FIGS. 7A, 7B, 7C, and 7D are diagrams of a material ribbon emerging from applicator dies of different design;

FIG. 8 is a block diagram of one of the methods described herein;

FIG. 9 is a block diagram of the method rocker panel anti-chip coating process;

FIG. 10 is a schematic diagram of a complete system; and

FIGS. 11A and 11B are full and partial plan views of the shim 26 of FIG. 5 overlying a die block 26 wherein FIG. 11B indicates a flow pattern found to be advantageous.

### DETAILED DESCRIPTION OF THE ILLUSTRATIVE EMBODIMENTS

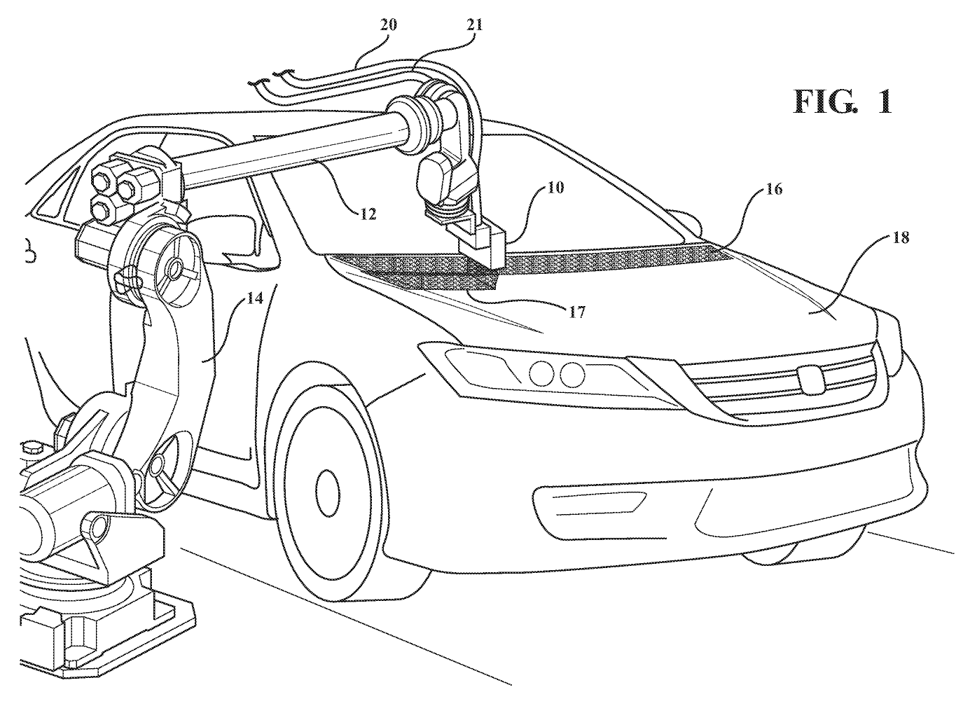

Referring to FIG. 1, an applicator die 10 is shown mounted on the end of an arm 12 of a numerically controlled multi-axis robot 14 capable of moving the applicator die in three-dimensional space as well as rotating the applicator die about multiple axes. The robot itself is conventional. The applicator die 10 is shown engaged in a process of applying 85 mm wide and 200 micron thick ribbons 16, 17 of polymeric film to the hood of an automotive vehicle which has been painted and essentially fully assembled, ready for shipment to a dealer. In FIG. 1, a first ribbon 16 has been applied across the rearmost portion of the hood 18; i.e., the portion closest to the windshield of the automobile, by moving the robot from right to left along a slightly curved path as shown in FIG. 1. The robot then indexed the arm 12 toward the front of the vehicle and is shown in the process of applying a second ribbon 17 moving from left to right across the hood 18 as seen in FIG. 1. Each ribbon is approximately 85 mm wide, and with an overlap with the adjacent ribbon or ribbons of about 1-7 mm. The preferred thickness profile for this particular application is uniform from edge to edge at about 200 microns.

The material being applied is an aqueous solution of polyvinyl acetate (PVA) at a temperature between about 70° and 120° F. and with a viscosity of about 3000 to 12,000 centipoise. Material is supplied to applicator die 10 under close temperature and flow rate control conditions via supply conduit 20; temperature-controlled liquid is supplied via conduit 21. The velocity of the material ribbon from the applicator can, for example, be as much as about 2000 mm/second and the robot 14 moves the applicator die 10 relative to the surface of the hood 18 at about that same speed. The spacing between the material outlet, i.e., the bottom edge of the applicator die 10 and the surface of the hood 18 is about 5 to 15 mm. The ratio of polymer to water in the applied material in an illustrative case is approximately 50/50 but will vary with the application. These figures are given by way of example. Robot speed, extrusion rate, spacing and emulsion ratios can all vary.

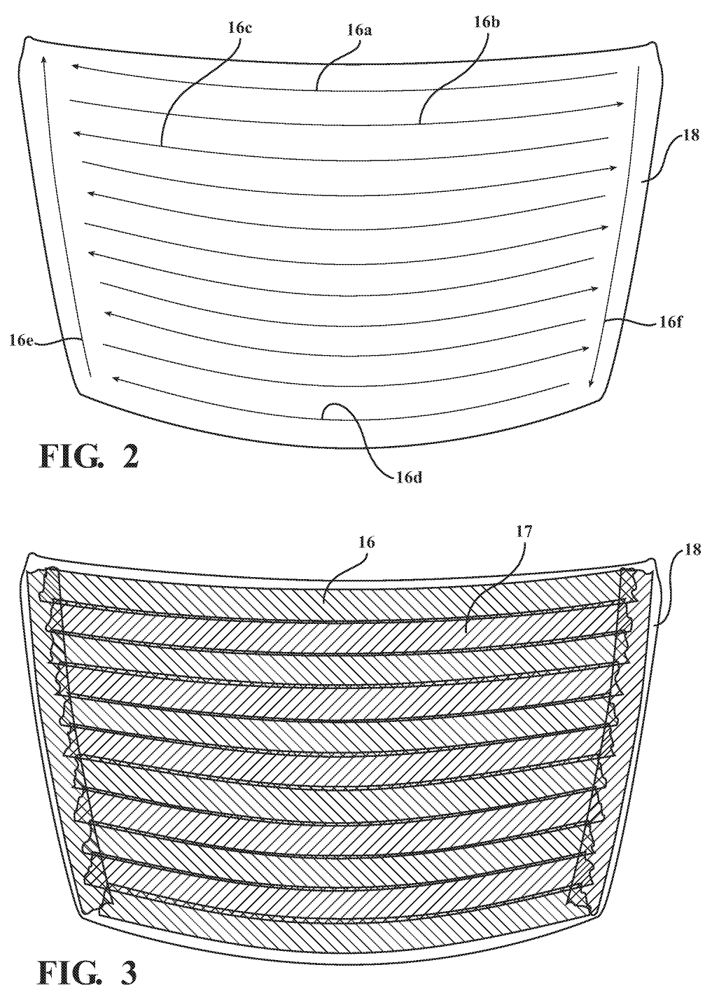

Referring now to FIGS. 2 and 3, the complete coverage of the hood 18 is achieved using crosswise movements to produce ribbons 16a, 16b, 16c and 16d in a back-and-forth fashion, the robot serving to index the applicator forward by just less than the width of the applied ribbon but without the need to rotate the applicator die 10 through 180° as the applicator die 10 is entirely ambidextrous; i.e., it has no “forward” side and operates in a spatial orientation nearly or completely orthogonal to the surface upon which material is being applied.

As shown in FIGS. 2 and 3, the material is applied to the surface of the hood in back-and-forth, overlapping ribbons until the forward-most ribbon 16d is applied at which time the applicator is rotated 90° and moved along the ribbon 16e to cover the left edge of the hood and the lateral ribbon ends, as shown in FIG. 2. The applicator is then moved to the top right portion of the hood, as shown in FIG. 3 to apply the final ribbon 16f. It will be noted that material is not applied across vehicle body seams. The pattern of ribbons in FIGS. 2 and 3 is illustrative only.

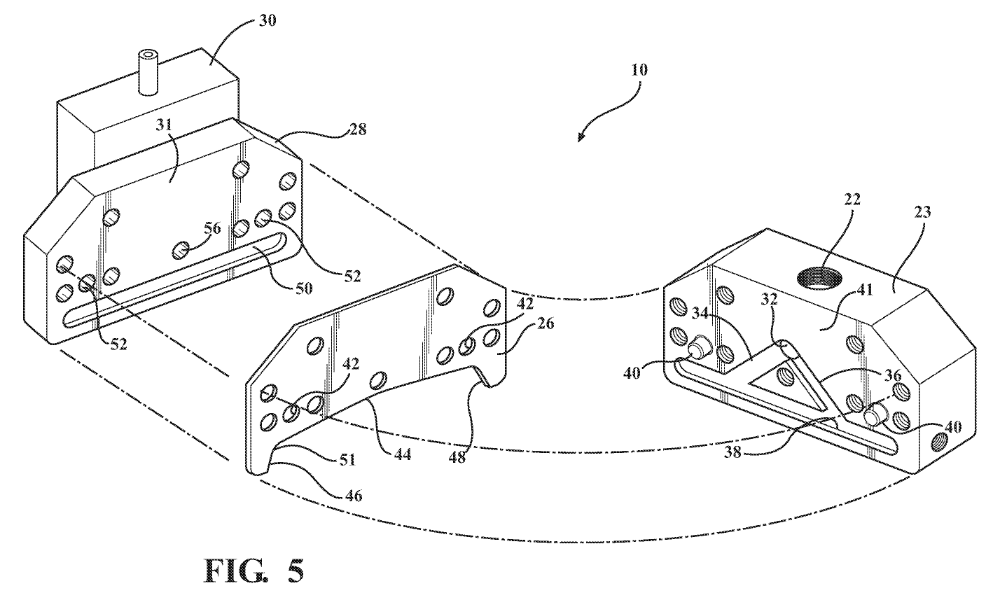

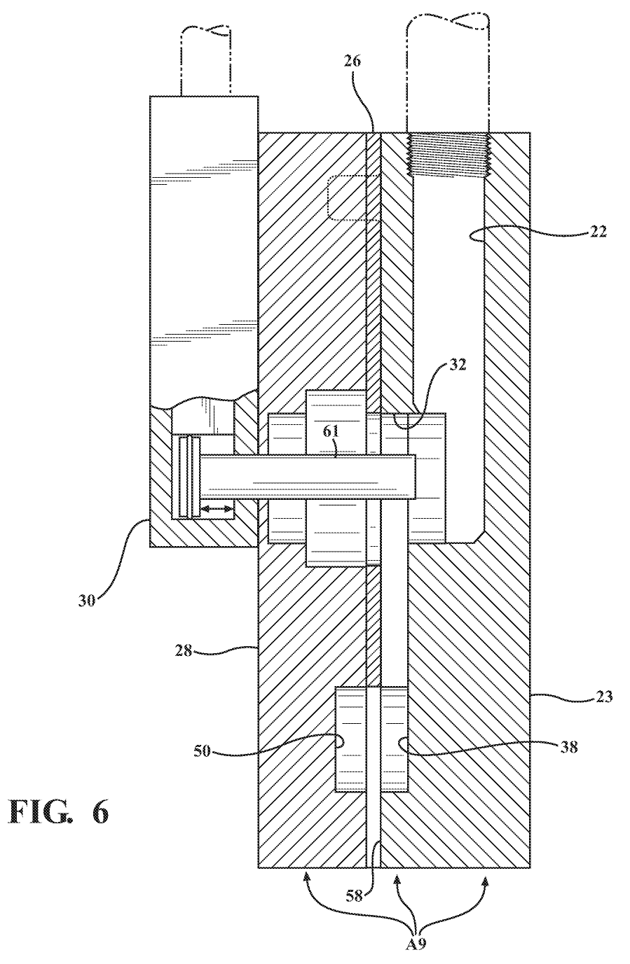

Looking now to FIGS. 5 and 6, an applicator die 10 is shown. It is referred to as an “applicator die” because the film ribbons issued from it are essentially hydraulically extruded as opposed to atomized or aerated and sprayed. There is no “spray” of particles or droplets. The term “hydraulic extrusion” is used herein to mean a laminarized flow or non-atomized fluid propelled by hydraulic pressure rather than by air or other compressible propellant. The applicator die 10 is shown to comprise blocks 23 and 28 which are machined out of solid stainless steel, for example, about 31 h″ long by 2″ high with rounded bottom corners and mitered top corners for weight reduction. Placed between the two blocks 23 and 28 in the assembled condition is a shim or spacer 26 made of brass, stainless steel, plastic or other suitable material having locator holes 52 so that it may be precisely located on guide pins 40 which are inserted into precisely located holes in the interior surface 41 of the block 23. A fourth element of the applicator die combination is a valve 30 which helps to produce sharper cutoffs as hereinafter explained.

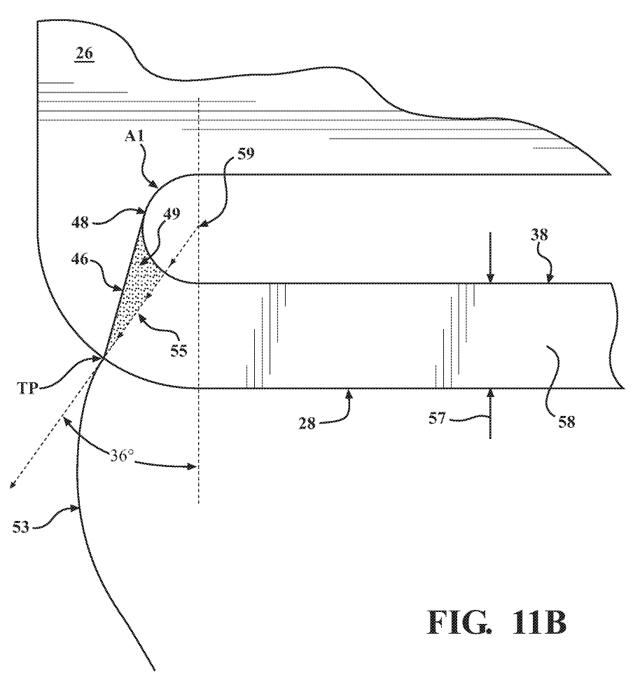

Block 23 is thicker than block 28 and includes a threaded material entry port 22 which extends downwardly to approximately the center of the block where it communicates with a forwardly directed passage 32 which, in tum, feeds material into a gallery of machined grooves comprising diverging legs 34, 36 and a horizontal cross-groove 38, all of which are of the same depth. A horizontal groove 50 is formed in the inside surface 31 of block 28 in full face-to-face registry with groove 38 in block 23 to create a gallery volume parallel to and adjacent the bottom edge surface of the die. The spacer 26 fits flush against the inside surface 41 of the block 23 to cover most of the grooves 34 and 36 of the gallery; the shim has a lower cutout or “relief” 44 with 15° flared side edges 46 and 48, which terminate at points TP on the radiused corner arcs of the die block which is 36 degrees from the vertical centerline as shown in FIGS. 11A and 11B. The shim provides a gap between the inside surfaces 41, 31 of blocks 28 and 23, respectively, of uniform thickness for material to flow downwardly from the horizontal grooves 38 and 50 and out through the bottom outlet 58 of the die, as shown in FIGS. 5 and 11. A preferred shim design is shown in detail in FIG. 11B. The ribbon of film preferably meets the target surface at a distance of between 5 and 15 mm from the bottom edge of the die 10, i.e., where the opposite sides of the ribbon have become essentially parallel.

Block 28 has locator holes 41 which receive the guide pins 40 and locate the block relative to the face 42 of the opposing block 23, as well as the hidden face of the spacer 26. Block 28 has a single horizontal gallery groove 50 which is opposite but co-extensive with the groove 38 within the relief 44 of the spacer 26 to allow the horizontal fluid chamber created by the two grooves 38, 50 to fill with the PVA material while preventing lateral outflow as well as up-flow between the spacer and the inside surface 41 of the block 23. An aperture 56 cooperates with the valve 30 to pull the pin 61 out of the flow chamber when cutoff is desired. This rapidly increases chamber volume and correspondingly reduces chamber pressure, resulting in a slight negative pressure with material pull-back. This feature is optional.

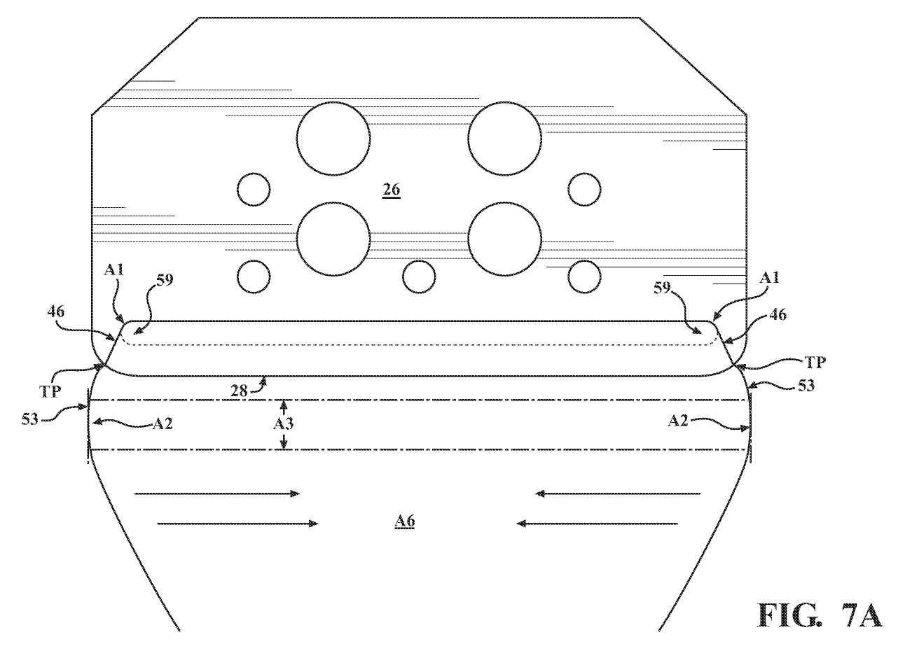

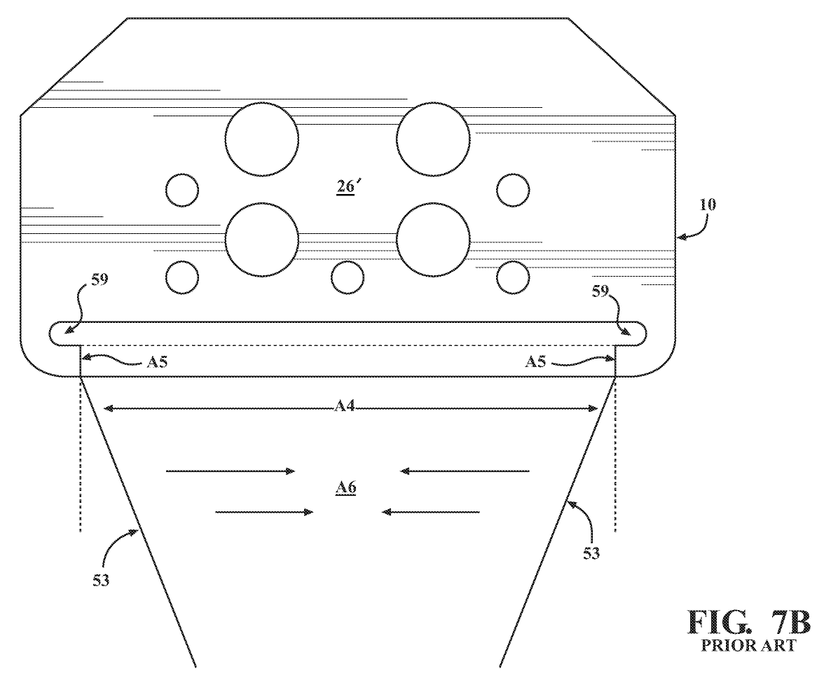

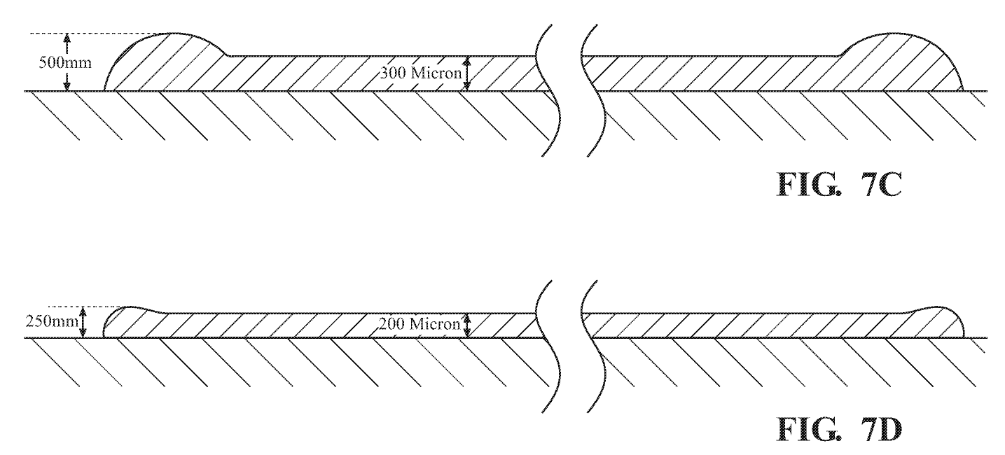

When applied to a fully finished painted surface for temporary protective purposes, the material applied is polyvinyl acetate in an emulsion containing, for example, about 50% water and 50% polymer. When dispensed, the material is extruded from the applicator die 10 with a width of about 85 mm. Thereafter, it has been found that the material begins to converge due to surface tension. Accordingly, the spacing between the outlet 58 of the applicator die 10 and the surface upon which the ribbons are being applied is preferably held such that the material is applied at or near the point of maximum width where the opposite edges are parallel. See FIG. 7.

As indicated above, the applicator die 10 can be moved at the selected rate over the target surfaces while material is dispersed or extruded therefrom. When placed in an infrared oven, drying time of about 15 minutes has been shown to be possible at a temperature of 180°. Convective and/or microwave drying can also be used.

It will be noted that the applicator die 10 is operated in a position which is orthogonal to the target surface rather than angled or tipped in the direction of flow as is the case with typical spray-type, deflective applicators. It will also be noted that the extruded ribbon of material being applied is not particled or atomized; rather, it is a full, continuous film of material moving outwardly and downwardly in laminar form and at a desired rate. Because the applicator is ambidextrous, it does not have to be turned around by rotation between parallel passes in opposite directions and this too, increases the rate at which an automobile body part, for example, a hood, can be covered. After coating, the component goes to an oven for faster curing. FIG. 7A shows how the film behaves as it leaves the applicator die 10. Because of the diverging or flared shape of the die exit slot, the ribbon diverges at 53 but quickly converges due to surface tension. The die-to-target spacing is preferably such as to apply the ribbon to the target surface at about the point of maximum ribbon width.

FIG. 7B shows how the extruded material behaves when using a straight sided spacer 26′ to define the die outlet slot 59 with edges A5. The material converges immediately upon departing the edges A5 due to surface tension; see ribbon edges 53 and becomes difficult to control.

FIG. 7C shows in profile two ribbons that can be created using the dies of FIG. 7A and 7B. The top ribbon A-8 is 300 microns thick and has 500 microns thick edge beads, measured at a distance of 10 mm from the die outlet. This is undesirable.

The bottom ribbon A-7 shows the ribbon profile produced by the invention die of FIGS. 5 and 11B. It is 200 microns thick with 250 microns edge beads at 10 mm from the slot outlet. This is the desirable profile. The very shallow edge beads promote clean peeling without excess material in the overlap areas or along the edges of the anti-chip coat.

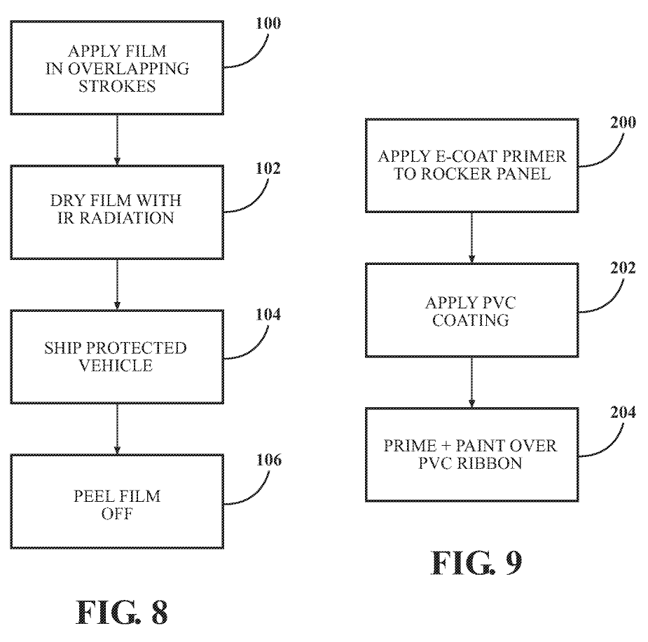

FIG. 8 is a schematic diagram of a method of applying a protective film of an automobile. The first step 100 as indicated by the legend is to apply the emulsion in overlapping and alternating strokes. The second step 102 is to dry the emulsion with infrared radiation. The third step 104, in the case of a manufactured automobile, is to ship the protected vehicle and the final step 106, typically performed by the dealer, is to peel the coating off the vehicle and dispose of it in an environmentally appropriate fashion. It peels in one piece and the material can be recycled.

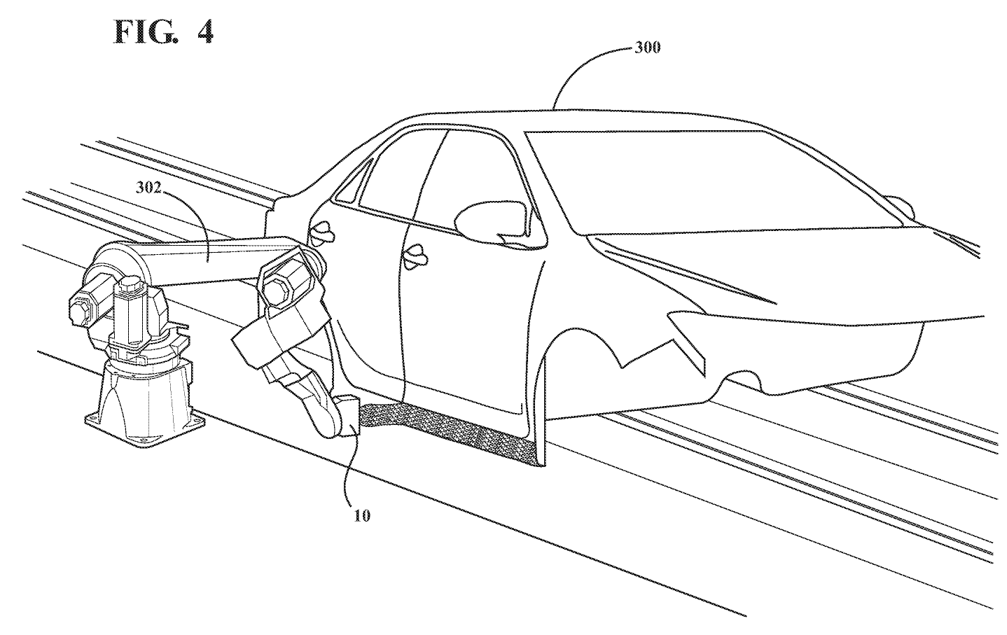

The method of using the applicator die 10 for the purpose of creating an anti-chip coating is shown in FIGS. 4 and 9. This method comprises a first step 200 of applying primer to a rocker panel of an automotive body 300 in conventional fashion; e.g., electro-coating. Thereafter, a robot 302 carrying an applicator die 10 essentially as shown in FIGS. 5 and 6 and described above is used in step 202 to apply an emulsion of a polymer such as PVC or a hybrid combination of PVC with other components to the primed rocker panel as an anti-chip coating. It will be understood that the applicator die 10 has material and coolant supply lines running to it as is the case for the film applicator in FIG. 1. In this case, the polyvinyl chloride solution or emulsion comprises a polymer in an organic solvent applied in a ribbon of the appropriate thickness while the rocker panel is essentially vertical. Temperatures, spacing and application rates are empirically determined. Depending on required width, two or more adjacent parallel applied ribbons may be required. The material may have a viscosity of about 30,000 centipoise to assure adherence to a vertical surface without running or sagging. It has been found that additional primer and body color paint can be applied over the PVC ribbon in step 204 before it is dried; i.e., paint can be applied “wet-on-wet.” The PVC surface produced by the applicator is glossy and uniform in thickness. In this embodiment, only one pass along the rocker panel is required. Where the rocker point is of constant width, the orientation of the die outlet usually remains normal to the direction of movement so the ribbon width is constant over the length of the panel. Where, however, the rocker panel narrows toward the end of its length, the robot carrying the die is programmed to turn the die about the flow axis enough to narrow the ribbon. Under these circumstances, the ratio of flow rate to die movement speed is controlled to maintain constant ribbon thickness.

Other materials that have been found effective include Henkel Teroson PV192US Underbody Coating containing PVC, a polyurethane resin and epichlorohydrin, Eftec EF0630 Underbody coating containing alkylsulfonic acid ester of phenol and polyisocyanate, Eftec EFCoat PBS04SD3 Antichip Coating containing bisphenol-A epoxy resin and nonylphenol, and Uniseal 4580 Stone-Guard Coating containing polyurethane pre-polymer plus bisphenol A epichlorohydrin. The preferred coatings are primarily PVC and/or hybrids of PVC but may be polyurethane, epoxy, or acrylic resins, either alone or in combinations.

There are numerous advantages to the use of this process for the anti-chip coating relative to the prior art process of spraying the coating on the car. Spraying requires the entire vehicle to be masked to protect it against overspray which is highly detrimental to paint finishes. Therefore, this method eliminates the need to mask the vehicle and to remove and dispose of the masking materials. In addition, the laminarized ribbon offers a smooth, glossy appearance as compared to the rough appearance caused by spraying.

FIGS. 11A and 11B show the preferred embodiment 88 of the extrusion die and especially the geometry of the relief 44 in the shim 26 relative to the groove 38 and the 180° rounded ends A-1 thereof. FIG. 11A shows the shim 26 overlying the die block 28 with the top edge 300 of the shim relief overlying and coextensive with the top edge of the gallery groove 38. The right and left corner or inside edges 46 and 48 of the shim partially follow the curve of the gallery groove end, but flare downward to points TP which are located at the 36 degrees point along the arc of the outer die block 28 corner radius. Both the right and left inside edge lines 46 and 48 of the shim, which begin at the outer radius point TP, terminate where they intersect the tangent of the half-circle (A-1) of the right and left ends of gallery groove 38. The right and left end-points of the shim at TP define the endpoints of the extrusion slot which will therefore determine the width of the ribbon as it emits from the slot. In FIG. 11B, the gallery groove radius (A-1) and the outer die block corner radius at point TP share the same centers of curvature 59. Therefore, the internal extrusion slot surface distance 57 over which the material exiting the die flows in contact with the slot surfaces 58 is constant from gallery edge to outlet edge, including the curved portions at the right and left ends of the slot which arc upward to the 36 degrees endpoint of the slot, as terminated by the edge 86 of the shim. This allows a uniform velocity of material emitting from the slot outlet face A-9 on the die block from ribbon edge to edge, all across the width of the slot. The ribbon trajectories will emit at an angle normal (perpendicular) to the slot face A-9 of the die block, which means that ribbon trajectories emitting at any point along the straight segment of the slot will all be parallel, but in the curved ends of the slot at the right and left corners of the die block, the trajectories will gradually diverge from zero degrees to 36 degrees at the right and left slot end-points at TP. This enables the outer right and left edges of the material ribbon 53 to exit the die slot at a trajectory 36 degrees from the centerline of the ribbon. Immediately as the ribbon emerges and flows out from the slot however in FIG. 7, the inherent surface tension A6 of the ribbon material will pull across the ribbon width to gradually arc the right and left edge trajectories inward toward each other an angle at first parallel (or zero degrees) to the centerline of the ribbon, and then will continue to arc inward to a final trajectory having a negative angle to the centerline of the ribbon (about −20 degrees). If allowed to continue, both ribbon edges would finally intersect, and the ribbon would undesirably coalesce into a rod or cylinder of free-flowing material, instead of a ribbon.

The zone of the emerging ribbon where the right and left ribbon edges are substantially parallel to the ribbon centerline at A-2, is designated the “zone of controlled film width and thickness” A-3, which is where the process of this disclosure is carried out. This sector of the ribbon extrusion, which is generally 5 to 15 mm from the face of the die block, has a substantially uniform edge-to-edge width (about 85 mm wide in this embodiment) and a constant film thickness of about 0.2 mm or 200 microns edge to edge. This ribbon zone of 5 to 15 mm from the slot face of the applicator, therefore defines the ideal range of distance (same 5-15 mm) for the applicator to dispense an optimum ribbon shape onto a surface. For this reason, robotic motion for dispensing ribbons is programmed such that the slot face of the applicator is taught a nominal 10 mm distance from the substrate surface. This will produce a wet ribbon extrusion on the substrate surface which will be of uniform width (85 mm, plus or minus 1 mm) and of uniform wet film thickness (0.2 mm). The only variance in wet film thickness across the width of the ribbon, are found at the edges, for no more than 1 mm inside the ribbon edge, where the wet material thickness is measured to be about 0.25 mm. (A-7 in FIG. 7C), This increased thickness (0.05 mm) which occurs within a millimeter from the right and left edges of the ribbon, is an advantage which enhances the peelability of the dry film when it is removed from the car body. Conversely, ribbon edges which are tapered under the 0.2 mm wet film thickness are a detriment in this application, since the tensile strength of the thinner film will be weaker than the adhesive strength holding the dry film to the substrate, and the dry film will tear at the edges during removal, leaving troublesome lines of dried film residue along the perimeter boundary of the ribbon pattern on the car body.

FIG. 7B shows the ribbon edge profile A4 produced by conventional extrusion means which are considered prior art, where the shim is trimmed at A5 (instead of at 46) which is at the right and left termini of the straight segment of the slot. This is a straightforward design which insures that all points of the ribbon emerging from the straight slot face are at the same velocity and in a parallel trajectory normal to (or perpendicular to) the slot face. Often, and especially with higher viscosity materials like clays and ductile metals, this will produce a ribbon of material having the same extruded width as the slot opening width of the die block. In the case of polymer emulsions however, which are relatively low viscosity liquids, the force of surface tension A6 in the liquid ribbon shape as it emerges from the die slot will immediately draw the ribbon edges together A4 as described above. This ribbon produced from the conventional design will have no parallel edges A2 for creating a “zone of controlled width and thickness” and can only emit a ribbon of constant width ribbon length and thickness at a distance no more than 1 mm from the die face A-9. The consequence of robotically applying transit coating from a die block only 1 mm from the car body surface is impractical and dangerous and therefore unfeasible. Applying a transit coating emulsion with this conventional die block design at the standard 10 mm distance (as used in the invention) would produce a narrower ribbon where the overall thickness of the ribbon will be greater than the specified 0.25 mm limit, and the ribbon edges will have grown considerably to 0.5 mm thick for a width of 3 mm or more (see A-8, FIG. 7B), will propagate drips and runs, and require considerably longer drying times for the thicker edge portions, which would also be unfeasible in production.

FIG. 11B shows the exit trajectory of the ribbon edge at TP aligned with the internal flow trajectory of the material 55 passing across the surface distance 57. The angle of flow trajectory 55 is defined by two points on this line: the radius centerpoint 59, and the shim termination point at TP. This line of trajectory (shown in this embodiment as 36 degrees from centerline) is also the shortest flow path for the material travelling across the slot distance 57, which will pass by the shim terminus at point TP to form the edge of the ribbon when it exits the slot. The difference between the 36 degrees flow trajectory angle at the end of the slot, and the angle of the shim edge 46 creates a triangular area 49 within the outlet slot where comparatively little material flow takes place. The triangular area 49 does however create an area of “laminar relief” adjacent to the flow path of the material which will form the edge of the ribbon. This feature of the triangular area 49 containing material adjacent to the main flow path for the ribbon edge contributes less resistance to the flow path than if the shim edge 46 were aligned directly along that path way at a 36 degrees angle. When the shim edges at 46 are aligned with the 36 degrees material path, they present a hard boundary adjacent to material flow across the slot distance 57, which slows the ribbon velocity at the edges when emerging from the slot face, causing increased thickness of the ribbon edge (>0.3 mm or 300 microns) when dispensed on the substrate surface, which is undesirable. The laminar relief created by area 49 creates less boundary impedance and consequently higher velocity for the adjacent faster-flowing material which will form the ribbon edge when it exits the slot, and thereby produces the ideal ribbon edge thickness (0.25 mm) on the substrate.

The ribbon edge exit angle which is controlled by the shim edge 46 and endpoint 47 were optimized at 36 degrees in the present embodiment to create the optimum “zone of controlled film width and thickness” for transit coating material application, and this was determined from observation and experimentation. However, other polymer emulsion formulas for other types of application, which may have a lower or higher viscosity, and/or a greater or lesser ribbon thickness requirement, may require a greater or lesser ribbon edge exit angle to optimize the zone of controlled width and thickness for that material and application. For this reason, the active range of this invention for the possible exit angles of the ribbon edge which will produce the optimized zone of controlled width and thickness will lie between 5 degrees and 50 degrees relative to the applicator centerline. Likewise, although the width of the peelable ribbon of the present embodiment is 85 mm, the straight segment of the applicator gallery and slot can be elongated considerably while preserving the radiused slot endpoint geometry to produce ribbon widths of 200 mm or even wider, or narrower ribbon widths could be produced by shortening the straight slot segment down to a ribbon width of about 25 mm. The scalability of ribbon width (25 mm or greater), and the range of viable ribbon edge exit angles (5 to 50 degrees) are inherent to the invention.

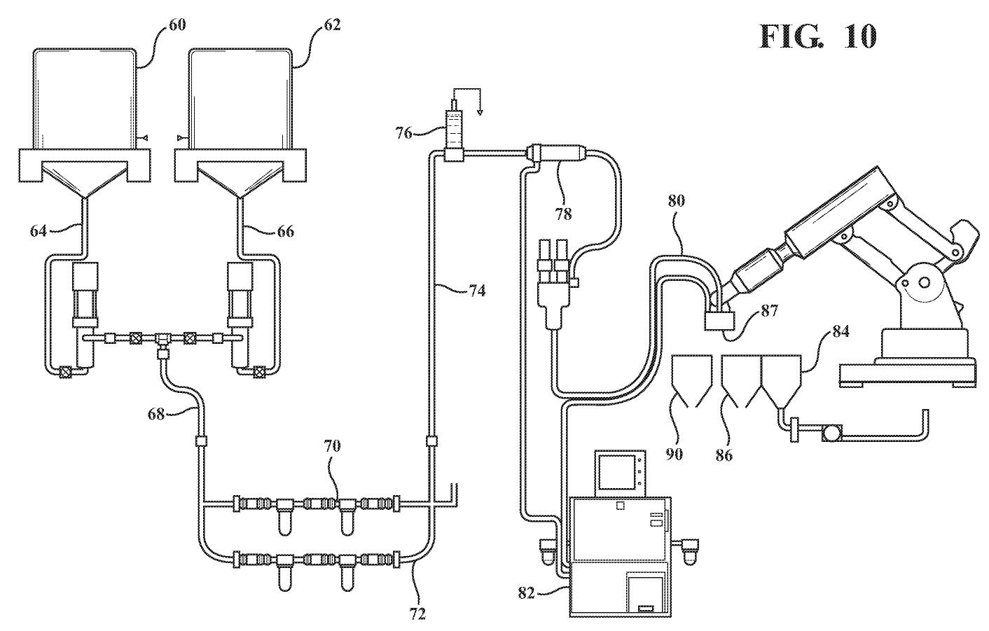

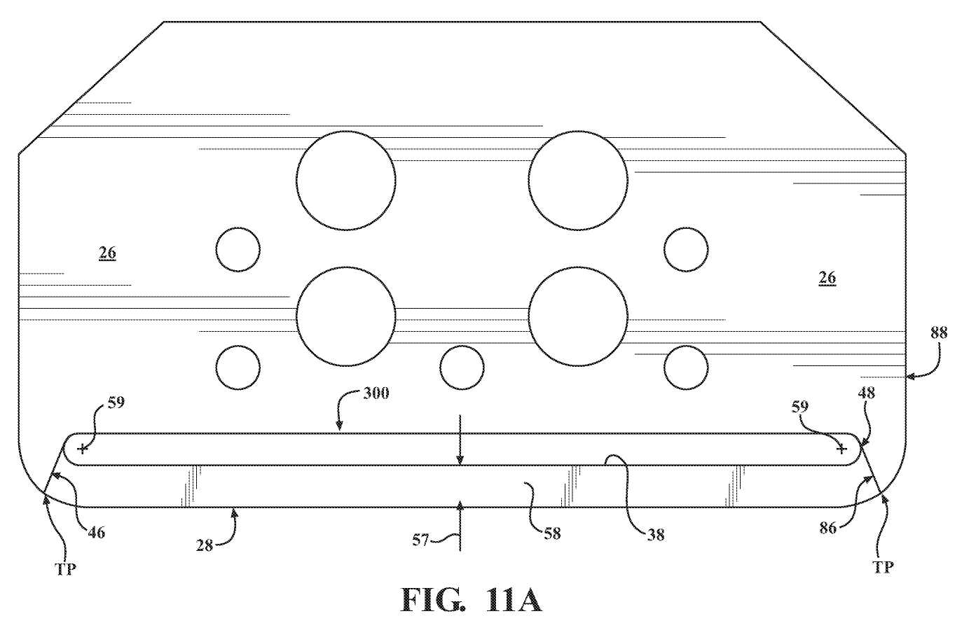

FIG. 10 is a schematic diagram of a representative system, in this case, for the application of the PVA film as a protective coating. However, the essentials of the system are the same for both applications described herein. As shown in the drawing, material is supplied from drums 60, 62 through lines 64 and 66 which are connected into a Y conduit 68 and from there through parallel legs 70, 72 with drains. Conduit 74 flows from the leg 72 through a filter 76 and from there into a heat exchanger 78 which is controlled by a temperature controller 82. Finally, the material flows into the conduits 80 which supply the applicator die 10. Adjacent the applicator die 10 in a standby position is a liquid-filled cleaning standby station 84 with an interior brush which can be activated as necessary. The fluid in the case of the aqueous PVA emulsion is water. Next to the cleaning standby station 84 is a cleaning station 87 where the applicator can be blow-dried. A purge station 90 may be used where desired.

Summarizing, the applicator die 10 uniquely dispenses a ribbon of material of uniform thickness at controlled speeds and with improved edge control. PVA in a water emulsion is used in the protective film application process of FIG. 8 or for masking. PVC in an organic emulsion is used for the anti-chip coating process of FIG. 9. The two examples demonstrate that the film ribbons can be applied to horizontal as well as vertical surfaces. They can also be applied to inverted and curved surfaces. Although a shim between the two body parts is shown, the objective is to shape the die outlet slot so that the side and bottom edges are such that (a) the film ribbon flares outwardly at about 36° and (b) the distance the film travels from the center of the gallery grooves to the bottom edge of the slot is constant across the slot width; i.e., from left radiused edge to the right radiused edge, thereby promoting a constant exiting film velocity across the ribbon.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of adheringly applying a ribbon of a polymer-based film as an anti-chip coating to the rocker panel of an automobile body comprising the steps of:
a. providing a fluidic polymeric solution to an inlet of an applicator configured to emit a non-atomized ribbon of said solution;
b. causing said solution to flow through said applicator to produce said ribbon from an outlet;
c. positioning the applicator near but not in contact with said rocker panel during production of said ribbon; and
d. moving the die along and relative to the rocker panel surface to cause the ribbon to adheringly contact the rocker panel surface.

2. The method defined in claim 1 where the solution includes one or more of polyvinyl chloride, polyurethane, epoxy, and acrylic resins.

3. The method defined in claim 2 wherein the solution includes an organic solvent.

4. The method as defined in claim 1 wherein the speed of movement between the die and rocker panel approximates the flow rate of the ribbon from the die.

5. The method as defined in claim 1 wherein the rocker panel is primed before the anti-chip ribbon is applied.

6. The process of claim 1 wherein the steps of applying the coating are carried out without masking the rocker panel.

7. A method of creating a uniform anti-chip film of polymeric material on a body panel surface including the steps of:
a. supplying a homogeneous fluidic solution of a polymer in a solvent to an inlet of an application die having an inner flow path from said inlet to an outlet having configuration capable of producing a non-atomized ribbon of fluidic material;
b. emitting said ribbon continuously from said outlet;
c. placing the applicator at known distance relative to a rocker panel of an automobile with the direction of fluidic emission substantially normal to the rocker panel surface so that substantially the entirety of the emitted ribbon adheringly contacts the panel surface; and
d. causing the applicator to move along and relative to the panel surface.

8. The method defined in claim 7 wherein the die is rotated about the axis of material flow to change the width of the pattern during the movement step.

9. The method defined in claim 7 wherein the rocker panel surface is painted after the application of the pattern but before the applied anti-chip material is dry.

10. The method defined in claim 10 wherein the method is carried out without masking off the rocker panel.

11. A method of finishing the rocker panels of a vehicle comprising the steps of:
a. priming a rocker panel surface;
b. robotically applying a non-atomized ribbon of a polymeric emulsion containing one or more of PVC, polyurethane, epoxy, or an acrylic resin onto the primed surface by extrusion; and thereafter,
c. painting over the applied ribbon.

12. The method defined in claim 11 wherein the ribbon has a thickness of about 300 to 350 mm.
